(19) United States
(12) Patent Application Publication
(10) Pub. No.: US 2014/0034860 A1
(43) Pub. Date: Feb. 6, 2014

(54) INDUSTRIAL VALVE

(71) Applicant: Claus Grosser, Aalen (DE)

(72) Inventor: Claus Grosser, Aalen (DE)

(21) Appl. No.: 14/008,028

(22) PCT Filed: Mar. 29, 2012
(86) PCT No.: PCT/EP2012/001393

§ 371 Date: Oct. 23, 2013

(30) Foreign Application Priority Data
Apr. 1, 2011 (DE) 10 2011 015 819.7

(51) Int. Cl. F16L 55/105

(52) U.S. Cl. CPC F16L 55/105
USPC 251/324

(57) ABSTRACT

The invention relates to a device (1) for complete or partial closing-off of a fluid-conveying pipe (2) which is under elevated pressure, wherein the device comprises the following: a pipe connector (3), a close-off element (6), and an actuating apparatus (8) for the close-off element, wherein the close-off element is a solid, unchangeable element which in the non-closing state is received in an extension (5) attached to the pipe connector in order to receive the close-off element, and is movable in a linear manner out of the extension into the pipe connector for the closing state.

### RELATED APPLICATIONS

This application corresponds to PCT/EP2012/001393, filed Mar. 29, 2012, which claims the benefit of German Application No. 10 2011 015 819.7, filed Apr. 1, 2011, the subject matter of which is incorporated herein by reference in their entirety.

### BACKGROUND OF THE INVENTION

The invention relates to a device for partial or complete closing-off of a fluid-conveying conduit or pipeline which is under elevated pressure. Such close-off devices are designed for retrofitting into an existing pipeline system. The existing pipeline does not have to be taken out of service for installation.

From DE 10 2007 0625 05 A1 a device for closing-off a fluid-conveying pipeline which is under elevated pressure is known, said pipeline having a pipe connector portion, said device comprising: a lock pipe connected to the pipe connector portion, an axially movable guide pipe arranged in a gas-tight manner in the lock pipe, so as to form a sealed space within the lock pipe, to which sealed space a pressurized gas may be applied, said guide pipe carrying an inflatable close-off element or plug member, which is connected to a filling line to which pressurized gas may be applied, and a control and regulating unit comprising at least one actuating element by means of which a pressure increase in the sealed space of the lock pipe can be caused by means of the pressurized gas, wherein at a predetermined first pressure difference or pressure head, the close-off element is inserted or tapped into the pipeline, and wherein at a predetermined second pressure difference or pressure head, the filling of the close-off element is effected so that the close-off element in the pipeline forms a positive shut-off or lock.

Such a device according to the prior art is only suitable for pressures of up to about 16 bar. Furthermore, it is difficult or even impossible, to achieve a precise or rated throttling of the pressurized fluid flow in the pipeline through the inflatable close-off element.

### SUMMARY OF THE INVENTION

It is therefore an object of the present invention to provide an improved device for closing-off a fluid-conveying conduit or pipeline under elevated pressure, wherein, on the one hand, the possibility of a completely or partially closing-off should be provided and, on the other hand, applications in pressure ranges of up to approx. 100 bar are possible, for example with gas pipelines such as for natural gas.

This object is achieved by a device for complete or partial closing-off a fluid-conveying conduit or pipeline under elevated pressure having the features of claim 1. Preferred embodiments of the invention may be gathered from the dependent claims.

The operator of a gas pipeline must be able to take measures upon incidents within a short time (typically about 30 min.) at any location of the pipeline system or network. The valve according to the present invention allows to specifically equip the pipeline system in such a way that via remote control technology or on-site staff a line can be closed off, throttled, or bypassed via a spare line. This provides significant cost savings, higher technical safety and security of supply.

This valve technology also offers the possibility to specifically equip an existing pipeline system or network with valves, without putting the pipeline system out of service. This solves a major problem due to which pipeline systems often have not been equipped with the necessary valves so far.

If, for example, repair or maintenance works have to be carried out in a pipeline system, the pipe portion to be treated can be closed-off selectively using a device or valve according to the present invention upstream and downstream of the concerned area or pipe portion. Due to the overflow or bypass function via a bypass line, supply can be maintained during the works.

The valve according to the present invention can be permanently incorporated in an existing pipeline system in a simple manner.

### BRIEF DESCRIPTION OF THE DRAWINGS

Further advantages and details of the invention will become apparent from the following detailed description of an embodiment with reference to the figures, in which

FIG. 1 is a side view of an embodiment of the present invention;

FIG. 2 is a front view of the embodiment of the present invention shown in FIG. 1; and

FIG. 3 is a sectional view taken along line CC in FIG. 2.

### DESCRIPTION OF THE EMBODIMENT

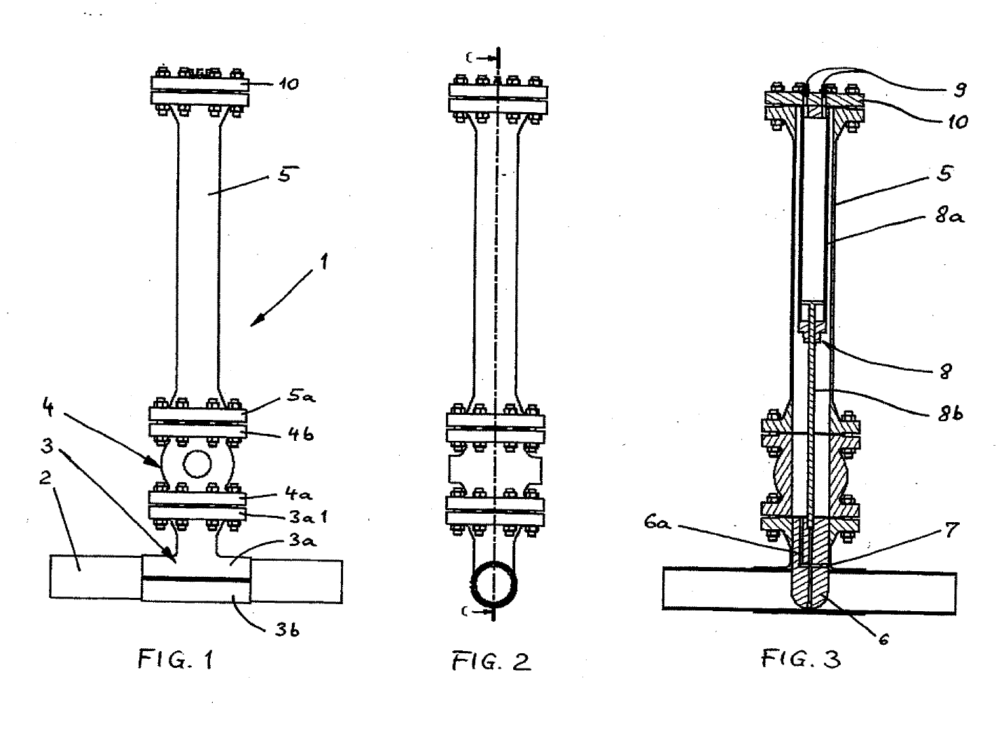

Referring first to FIGS. 1 and 2, a device 1 according to the invention for completely or partially closing-off a fluid-conveying pipeline 2 under elevated pressure is shown. The device 1 comprises a conventional pipe connector 3 designed as a T-fitting. The pipe connector 3 consists of two parts, a first part 3a forming the T-connection and comprising a flange 3a1 for connecting to other components, and a second part 3b being essentially channel-shaped or trough-shaped and surrounding the pipeline 2 in combination with the first part 3a. The first part 3a of the pipe connector 3 is fixed to the second part 3b thereof, for example by welding or by other suitable fixing means.

According to the preferred embodiment shown, a close-off device 4 is fixed to flange 3a1. The close-off device 4 is preferably a ball valve, but may also be a slide valve. The close-off device 4 comprises a first flange 4a and a second flange 4b. The first flange 4 is connected to flange 3a1 of the pipe connector 3. The second flange 4b is connected to a corresponding flange 5a of a substantially tubular extension 5.

FIG. 3 shows the device or valve according to the present invention in a sealing condition. Therein, a mandrel or plug 6 blocks pipeline 2 and thus closes it off. The plug is a solid close-off element or body that is unchangeable regarding shape and size, and which can be moved linearly from extension 5 into pipeline 2. Preferably, the plug 6 is an elongated, substantially cylindrical solid body of circular cross section and having a spherically rounded tip. The cross section of plug 6 matches the free internal diameter of the T-branch of pipe connector 3. This diameter also corresponds to the free diameter of the ball valve 4 in a fully opened state as well as the free inner diameter of extension 5 so that the pin can move out of extension 5 into pipeline 2 in a sliding fit. Preferably, the plug 6 is made of metal, but it may also be made of other suitable materials, for example a plastic or ceramic material, depending on the respective field of application. Plug 6 comprises a groove in which a sealing 7 is received. Sealing 7 has an annular shape and is made of a conventional sealing material, such as rubber, gum, polyethylene, elastomer, or other suitable plastics. Sealing 7 spans or extends over the substantially hemispherical tip of plug 6 and extends around a part of the circumference of plug 6, to seal, on the one hand, against the inner wall of pipeline 2 and to seal, on the other hand, against the inner surface of the pipe connector 3 in the area of the T-fitting. The radius of the hemispherical tip of plug 6 is adapted to the cross-sectional radius of pipeline 2.

Plug 6 comprises at least one passage 6a, through which pressure can be applied to sealing 7 hydraulically or pneumatically, in a direction out of the groove and sealing against pipeline 2 and pipe connector 3, respectively. Preferably, passage 6a is connected via a corrugated or flexible tube (not shown) to a control terminal or port (not shown).

By means of an actuating device 8, plug 6 can be moved into and out of the blocking or close-off position in pipeline 2. The actuating device 8 comprises an operating cylinder 8a and a piston with a piston rod 8b. One end of piston rod 8b is fixed to plug 6, whereas the opposite end of piston rod 8b is fixed to the piston that is located in the operating cylinder 8a. The actuating device 8 can be operated hydraulically or pneumatically. Connection ports 9 are provided for actuation, which are connected to a control unit (non shown) with a storage vessel for the operating fluid. The connection ports 9 can advantageously be formed in a lock or cap 10 attached to the extension 5. Likewise, the control terminal or port for passage 6a of plug 6 for actuating sealing 7 may be formed in lock or cap 10. The lock or cap 10 is fixed to a flange 5b of extension 5.

When installing the device or valve 1 according to the present invention, the T-fitting for tapping (pipe connector 3) is first placed on pipeline 2, and the parts 3a and 3b are welded together and to pipeline 2 to form a tight or sealed connection. Subsequently, the ball valve 4 is screwed on or secured in any other appropriate manner. On ball valve 4, a drilling device is mounted in a conventional manner known in the art. After opening the ball valve 4, pipeline 2 is drilled or tapped through the holes in ball valve 4 and pipe connector 3. After pulling out the drilling device, the ball valve is closed and the drilling device is removed. Then extension 5 with the plug 6 and actuating device 8 is mounted on ball valve 4 and secured to it. Then, the device or valve of the present invention is ready for operation. Either by remote control or by operation on site, the actuating apparatus 8 can be operated and can move plug 6 linearly into pipeline 2 for close off the pipeline 2. To improve the sealing effect, additionally sealing 7 can be expanded or extended by applying hydraulic or pneumatic pressure which is supplied through a passage in plug 6.

By controlling the actuating device 8, the device or valve 1 according to the invention can be arbitrarily opened and closed, and in particular also partially.

The device or valve 1 is suitable for closing off fluid-conveying conduits or pipelines under elevated pressure, not only in the low pressure range up to about 16 bar, but also in the high pressure range up to about 100 bar.

The above description relates to a preferred embodiment of the invention. Modifications of the invention are possible and are readily discernable from the above description for someone skilled in the art.

1. A device (1) for completely or partially closing-off of a fluid-conveying pipeline (2) under elevated pressure, said device (1) comprising:
a pipe connector (3),
a close-off element (6), and
an actuating device (8) for close-off element (6),
wherein the close-off element (6) is a solid, unchangeable body which in the non-closing state is received in an extension (5) attached to the pipe connector (3) for receiving the close-off element (6), and is moveable in a linear manner out of the extension (5) into the pipe connector (3) for the closing state.

2. The device according to claim 1, further comprising a close-off device (4).

3. The device according to claim 2, wherein close-off device (4) is a ball valve or a slide valve.

4. The device according to claim 2, wherein the close-off device (4) is attached to the pipe connector (3), and wherein the extension (5) is attached to the close-off device (4) for receiving the close-off element (6).

5. The device according to claim 1, wherein the pipe connector (3) is a T-fitting.

6. The device according to claim 1, wherein the close-off element (6) is a solid mandrel or plug.

7. The device according to claim 1, wherein the close-off element (6) further comprises a sealing (7) for sealing against the pipeline (2).

8. The device according to claim 7, wherein the sealing (7) has an annular shape.

9. The device according to claim 7, wherein the close-off element (6) comprises a groove and wherein the sealing (7) is arranged in the groove of the close-off element (6).

10. The device according to claim 9, wherein the close-off element (6) comprises a passage (6a) through which pressure can be applied to the sealing (7) either hydraulically or pneumatically in the direction out of the groove and in a manner sealing against the pipeline (2).

11. The device according to claim 1, further comprising a control unit with a storage vessel.

12. The device according to claim 1, wherein the actuating device (8) for the close-off element (6) is arranged in the extension (5).
